(19) United States
(12) Patent Application Publication
(10) Pub. No.: US 2014/0164901 A1
(43) Pub. Date: Jun. 12, 2014

(54) METHOD AND APPARATUS FOR ANNOTATING AND SHARING A DIGITAL OBJECT WITH MULTIPLE OTHER DIGITAL OBJECTS

(71) Applicant: Tagaboom, Inc., Austin, TX (US)

(72) Inventors: Steven R. McDowell, Alvin, TX (US); Martin D. Seyer, Austin, TX (US)

(73) Assignee: Tagaboom, Inc., Austin, TX (US)

(21) Appl. No.: 13/951,680

(22) Filed: Jul. 26, 2013

Related U.S. Application Data
(60) Provisional application No. 61/676,046, filed on Jul. 26, 2012.

(51) Int. Cl. G06F 17/24

(52) U.S. Cl. CPC G06F 17/241
USPC 715/233

(57) ABSTRACT

This disclosure describes a method and apparatus for annotating and sharing a digital object with multiple other digital objects. The invention presented addresses these deficiencies by defining a mechanism and apparatus for taking a digital object, be it a text document, still image, or other object, and allowing annotations associated with that digital object to be both authored and consumed by multiple sources in a collaborative environment. Further, the invention provides mechanisms for controlled consumption of the annotation, and the solicitation and reservation of annotation between multiple users.

### CROSS REFERENCE TO RELATED APPLICATIONS

This application claims priority and the benefits of the earlier filed Provisional Application USAN 61/676,046, filed Jul. 26, 2012, which is incorporated by reference for all purposes into this specification.

### TECHNICAL FIELD

The present invention is in the technical field of digital media and collaboration. More particularly, the present invention is in the technical field of the storage and presentation of digital media with associated annotation for the purpose of both general consumption and collaboration. And even more particularly, the present invention discloses a method and apparatus for annotating and sharing a digital object with multiple other digital objects.

### BACKGROUND ART

Traditional methods of supplementing a digital media object with annotation vary. Images can be annotated with audio content by converting the associated coupling of images and audio into a video or movie file. Text-based documents have traditionally not been annotated with media, but rather text-based annotation contained within the document itself. There exists no convenient and coherent method for taking a digital object, be it a text document, still image, or other, and directly annotating it with media, whether audio or other, text, or other digital objects

Beyond annotation of digital objects, today's methods of collaboration and communication make it impractical to hold and share a constrained conversation focused around a single topic instantiated by or otherwise related to the contents of a digital object. Traditional digital communication technologies are point-to-point in nature, transitory in time, meaning extraordinary steps are required to archive and later retrieve such communications, and require near real-time participation.

### SUMMARY OF INVENTION

This disclosure describes several embodiments for annotating and sharing a digital object with multiple other digital objects. The first embodiment describes a method for instantiating a digital annotated object that includes providing a central object containing media content created by a creating user, wherein a digital object with related and extensible annotated objects can be formed. This embodiment provides a mechanism for that creating user to set access control parameters to limit actors who may provide annotation in the form of related media objects. Further, this embodiment provides a number of related media objects that refer to the original object that serve to annotate that object with additional content. In addition, this embodiment provides a means for allowing additional related media objects to be created by actors other than the creator of the original digital object. Additionally, this embodiment provides a means for digitally representing the relationships between the various media objects that serve as both central object to be annotated and objects that serve as the annotation.

The next embodiment describes a method of providing annotations that reflect an actor's intended emotional response, wherein a digital object with related and extensible annotated objects specific to the actors intended emotional state or response is reflected. This embodiment creates a central digital object that is enabled for annotation. This embodiment then provides a mechanism for providing related media object that reflects opinion or emotion with audio or visual media corresponding to that emotion.

The next embodiment describes a method of instantiating a digital annotated object that is derived from an existing digital annotated object, wherein a digital object with related and extensible annotated objects is created that contains extensible annotated objects as its own annotation. This embodiment creates a digital annotated object as step (a). Next, this embodiment provides in step (b) a mechanism for importing an additional digital annotated object that itself is to provide annotation to the object described in step (a). Then, this embodiment provides in step (c) a mechanism to allow further annotation both on the original digital object in step (a) and the digital annotated object that is itself an annotation in step (b).

The next embodiment describes a method of providing and soliciting annotations for a digital annotated object, wherein a digital object with related and extensible annotated objects is created that contains placeholder annotations reserved for certain actors, with a notification mechanism for those actors to be notified that the placeholders exist. This embodiment provides a central object containing media content. Next, this embodiment provides a mechanism for allowing related media objects that serve as annotation to the original digital object. Further, this embodiment provides a means for reserving the use of some number of annotations to the original object to be annotated for population by certain actors. And then, this embodiment provides a providing a mechanism for notifying certain actors that an annotation is reserved for that actors use.

The next embodiment describes a method of consuming annotations on a digital annotated object, wherein a means and mechanism for consuming media annotations related to a digital annotated object can be achieved in a controlled and unique fashion. This embodiment provides a central object containing media content and related media based annotations. Next, this embodiment provides a means of replaying the media based annotations in an order proscribed by the creator of the central object. Further, this embodiment provides a means of replaying the media based annotations in an order proscribed by the creator of the annotation. Additionally, this embodiment provides a means of replaying multiple annotations simultaneously to provide various effects on the consumer. And then, this embodiment provides a mechanism to provide the conversion of the digital annotations into a format and object that can be consumed outside of the constraints of the system which embodies the disclosed invention.

### BRIEF DESCRIPTION OF DRAWINGS

To further aid in understanding the disclosure, the attached drawings help illustrate specific features of the disclosure and the following is a brief description of the attached drawings:

FIG. 1 is a presentation of the concept of associating multiple means of audio annotation with a given digital object.

FIG. 2 is an illustration detailing multiple streams of text and audio annotation associated with a digital object.

FIG. 3 is an illustration detailing the inclusion of video and other digital animation, as well as audio and text, as annotation to a given digital object.

FIG. 4 is an illustration of a mechanism wherein an annotated digital object is itself an annotation of another annotated digital object.

FIG. 5 is a flow-chart detailing the mechanism wherein multiple streams of annotation are combined to deliver a single annotated digital object.

FIG. 6 is a flow-chart detailing the mechanism wherein annotation can be solicited from others beyond the creator of the source object.

FIG. 7 is a flow-chart detailing the mechanism wherein multiple annotations by multiple producers can be synchronized to be consumed simultaneously to create unique effect to consumer.

FIG. 8 illustrates an embodiment of the disclosed invention using a global communications networks such as the Internet.

FIG. 9 illustrates another embodiment of the disclosed invention using a global communications networks such as the Internet.

### DISCLOSURE OF EMBODIMENTS

This disclosure describes a method and apparatus for annotating and sharing a digital object with multiple other digital objects. This disclosure describes numerous specific details in order to provide a thorough understanding of the present invention. One skilled in the art will appreciate that one may practice the present invention without these specific details. Additionally, this disclosure does not describe some well known items in detail in order not to obscure the present invention.

The disclosed invention addresses the lack of a convenient and coherent method for taking a digital object, be it a text document, still image, or other object, and directly annotating it with media, whether it be audio, text, or other digital object, and making such annotation available for both multiple consumers, and producers, of the digital objects, for the purposes of, but not limited to, collaboration and general communication and consumption.

The disclosed invention addresses these deficiencies by defining a mechanism and apparatus for taking a digital object, be it a text document, still image, or other object, and allowing annotations associated with that digital object to be both authored and consumed by multiple sources in a collaborative environment. Further, the disclosed invention provides mechanisms for controlled consumption of the annotation, and the solicitation and reservation of annotation between multiple users.

The disclosed invention also addresses short-comings in today's methods of communication and collaboration. The disclosed invention integrates with existing technology, computer networks, and computing and communication devices to provide a mechanism by which asynchronous conversations can be focused around a subject instantiated or related to a digital object, where such conversations are not bounded by time, technology, or geographic location, and which are controlled, archived, searchable, and exportable to other technologies wherein they may be broadly consumed.

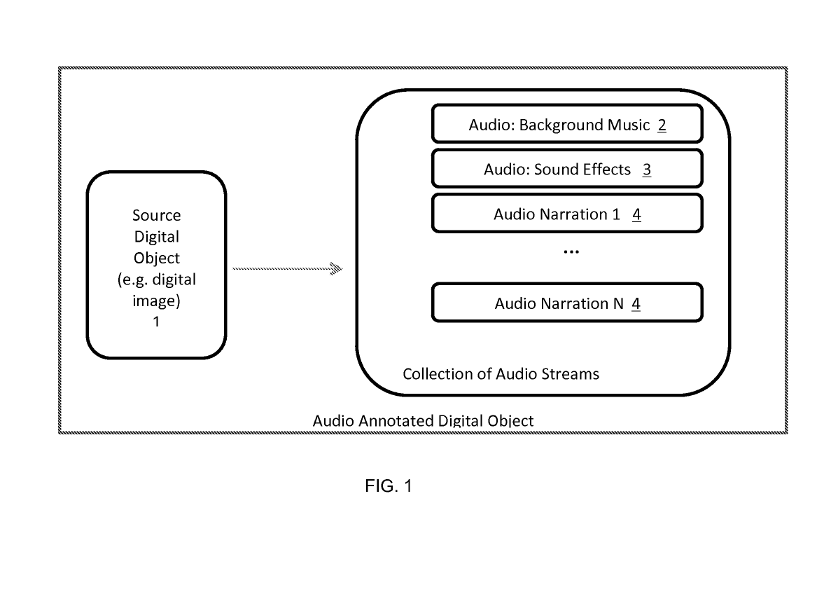

Referring now to the disclosed invention in more detail, FIG. 1 illustrates a source object, 1, such source object being a digital still image, audio file, animation, document, digital movie or animation, or other user created media, and associating it with a number of audio annotations by addition such as, but not limited to, background music, 2, sound effects, 3, and multiple elements of existing and new narration, 4.

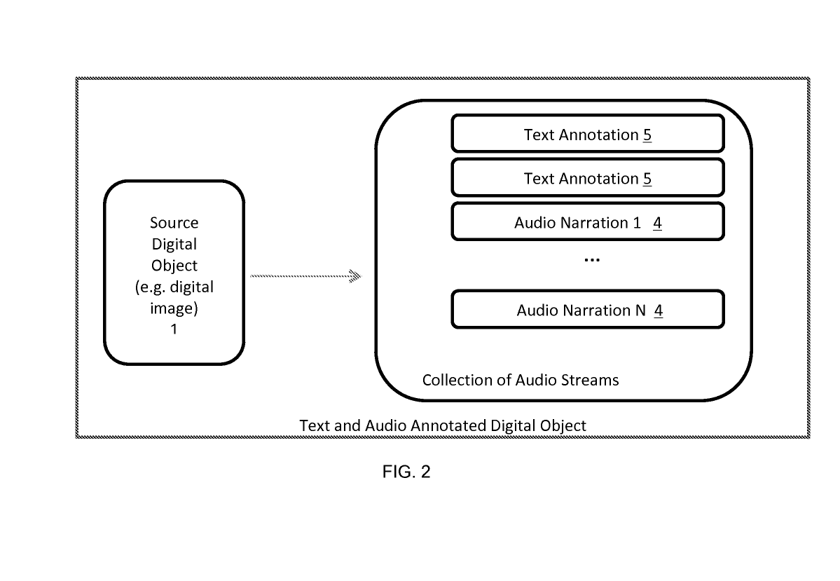

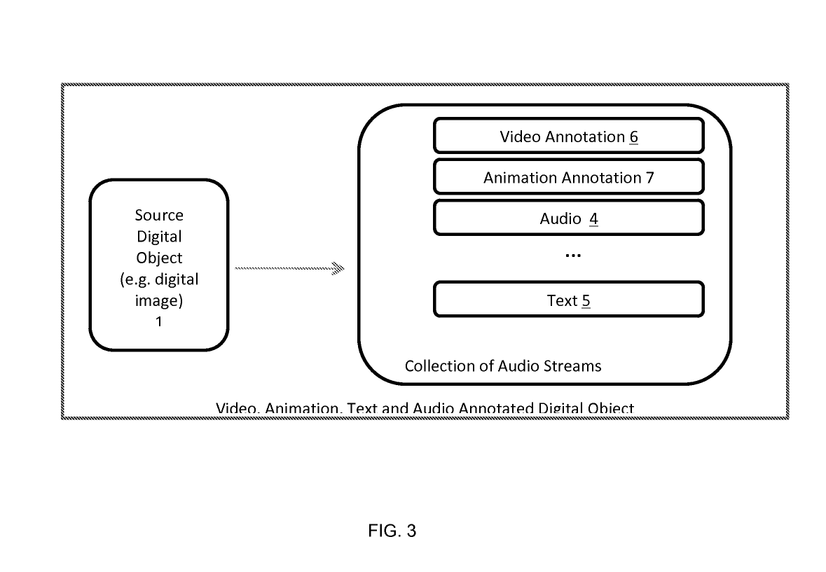

In further detail, FIG. 2 extends the concept of taking a digital object, 1, with audio annotation, 2, 3, and 4, and including text, 5, as part of the delivered annotation. FIG. 3 likewise includes video, 6, and digitally animated objects, 7, as another implementation of annotation for the source object, 1.

Annotations may further include programmatic, visual, audio, or other representation of a user's “emotion”, meaning that a user can express opinion on a source object, or annotation related to the source object within the total annotated object with that opinion being reflected within an annotation. A practical example of this would be, but not limited to, a user indicating that the user “likes” the object, with a corresponding sound effect or graphic indicating such “like”.

Annotations may also include media that is imported, either manually by the user of via programmatic means, from separate computing and audio and visual devices, for example, but not limited to, digital cameras, digital video cameras, scanners, media players, or other devices which may generate digital objects suitable for use as annotations.

The annotations described by FIG. 1, FIG. 2, and FIG. 3 are coupled to create a completed annotated object.

Further, the source object, 1, may be an object retrieved from another source, database, web-site, or other digital repository, that already has a loose association of related data. An example of this would be a photo-sharing website that allows third parties to deliver comments in a separate forum that are related to a shared photo. The disclosed invention described here-in would allow that shared photo to be leveraged as a source object, as described, and further allow each of the comments related to that photo be treated as annotations to that source object, creating an annotated object.

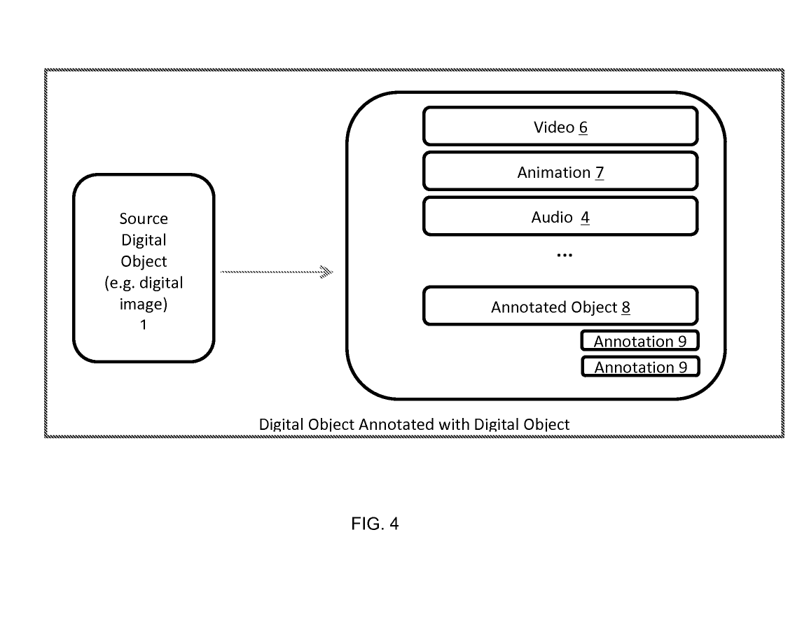

The digital annotations described by FIG. 1, FIG. 2, and FIG. 3 are combined and related to a source object to produce a completed annotated object. The completed annotated object previously described can itself become an annotation to a new source digital object, creating a derivative annotated object, which is illustrated in FIG. 4.

Further, the source object, 12, can itself be modified by a user, 15 or 18, and treated as a separate annotation. An example of this is, but is not limited to, the case where a source object may be a digital image, and a contributing user, 15 or 18, modifies the image with enhancements or notations, and submits that modified image as an annotation to the annotated object.

FIG. 4 illustrates that a completed annotated object, 8 and 9, can itself be embedded into a source object, 1, to produce a new annotated object that contains the potential combination of text annotation, audio annotation, 4, video, 6, and animated annotation, 7, as well as a completed annotated object, 8 and 9.

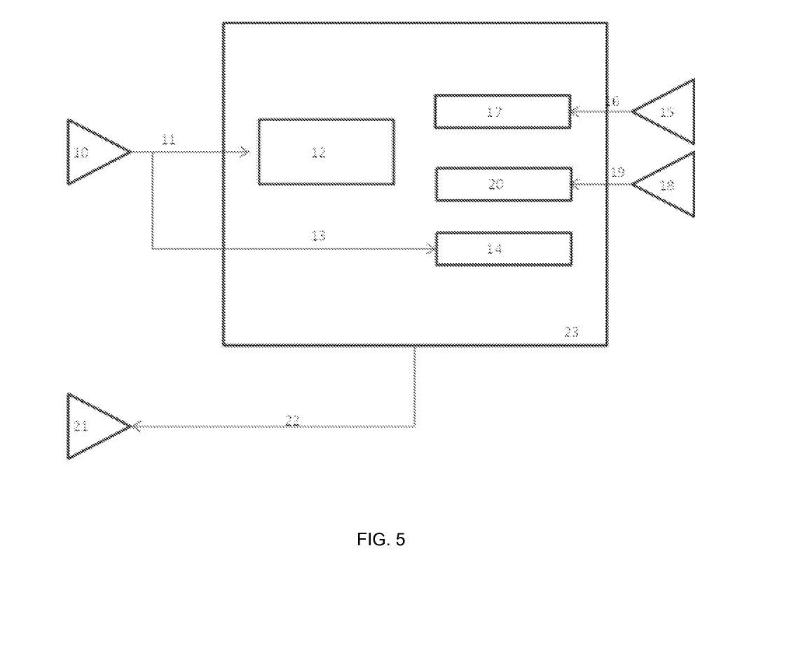

In more detail, the mechanism wherein an annotated digital object is created is illustrated in FIG. 5. A user, or an automated mechanism, noted by symbol 10, creates a source object, 12, The source object can be any digital media object, inclusive of audio, video, drawings, faxes, scans, or computer generated documents of any sort, or which could be “blank” or a null object, with null object being a placeholder around which annotations may be placed, with actual source object being contributed at a later time, or not at all.

The user, 10, creates annotation, 13, as defined in the previous paragraphs, related to the source object, whether actual or null, 12, and submits the annotation and the source object to a relational database system in order to instantiate a unique relationship between the annotation, 14, and the source object, 12. The combined act of creating this relationship, 11 and 13, establishes a relationship between the object, 12, and the annotation, 14, to create an annotated object, 23.

The relational database system described may reside on a central computing system, or may be implemented within a consumption device, such as a mobile computer system, desktop computer system, or other computing device both known and unknown. It is a feature of the disclosed invention that the set of relationships that define an annotated object are distributed and not specifically linked to a specific user.

The act of creating the annotated object, 23, allows for further annotations to be contributed by the original creator, other users, or other automated mechanisms. This is further illustrated in FIG. 5. As an example, a user, 15, can create and submit, 16, a text annotation, 17, that then becomes a part of the annotated object, 23. Likewise, a user, 18, can create and submit, 19, an audio annotation, 20, that also becomes a part of the annotated object, 23.

The annotations, exampled by 17 and 20, may become a part of the annotated object as submitted by the contributing users, 15 and 18, or they may undergo programmatic enhancement of the contributing user's choice. Such enhancement may be to add emotional effect to the annotation, for example, and not limited to this example, by modifying the pitch of an audio annotation of the user's voice to be cartoonish or otherwise affected. Such enhancement may also be, but is not limited to, the improvement of the quality of the audio, video, animation, or other digital object that is submitted as annotation.

Annotations may be related to other annotations, not just the source object. The relational database system previously described maintains notation as to whether an annotation relates to the source object, or relates to another annotation within the annotated object. The playback and consumption mechanisms will relay that relationship to the consuming user, causing the user to consume the annotation in the appropriate context.

The creating user, 10, and any contributing users, exampled by 15 and 18, need not be on related computer systems or data networks. It is a feature in the disclosed invention that users of disparate computer systems with varying capabilities, and disparate data networks, may collaborate to deliver an annotated object. While the annotated object is maintained within a central computing system, users, both creating users and consuming users, may access and modify the annotated object from disparate technologies and geographies.

The annotated object, 23, may then then be consumed by a user, 21. The act of consumption, 22, allows the user to view or otherwise examine the source object, 12, and any combination of related annotations, 14, 20, and 17.

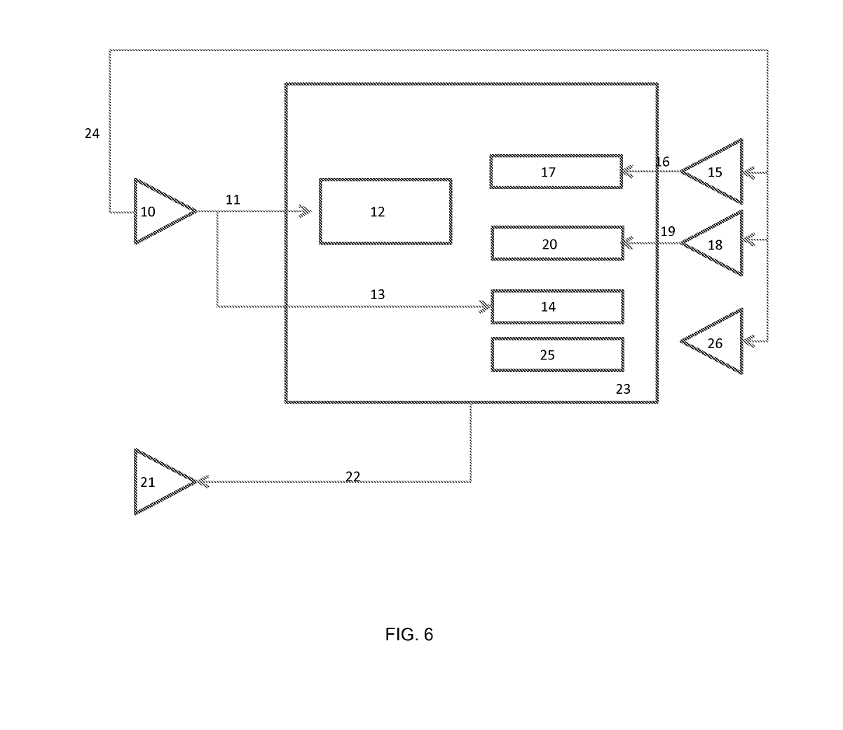

Further detail of the disclosed invention describes that during the act of creating an annotated object, 11, allows for the creating user, or automated process, to solicit annotations from other producers, whether user, group of users, automated processes, or some combination those. This act of solicitation is detailed in FIG. 6.

The originating user, 10, creates, as previously described, an annotated object, 23, by combining a source object, 12, and an annotation, 14. Subsequent to this act of creation, 11, the user may trigger a notification, 24, to other users, or to automated processes, to solicit contribution of new annotation for the digital object, 23.

The users solicited may be known to the originating user, 10, or may be unknown and provided to the originating user via other mechanisms. An example of this may be, but is not limited to, an annotated object being used for advertising or other commercial use wherein a number of “anonymous” contributing users wish to be notified when content is posted by the originating user, and register with a central system to be provided such notification.

The notification described may be implemented as electronic mail, SMS message, programmatic signal between multiple elements of software within the implementation of the disclosed invention, or other common or novel notification systems. The uniqueness of the disclosed invention is not the mechanism of notification, but that a user can generate notifications to external users, or automated processes, to solicit annotations for the annotated object from those same users, or automated processes.

The notification, 24, is received by users or automated processes, 15, 18, and 26. Those users, or automated processes, then have the option to respond to the notification and annotate the digital object, 23. As example, in the case of the flowchart presented in FIG. 6, user 15 contributes an annotation, 17, user 18 contributes an annotation, 20, while user 26 does not contribute an annotation, but has a annotation location within the annotated object, 23, reserved, 25.

Beyond the act of creation, previously described, both the originating user, 10, and any contributing users, exampled by 17 and 18, maintain the ability to delete, modify, and otherwise manipulate a contributed annotation.

Further, the disclosed invention includes the mechanism wherein the user, 10, who creates the annotated object, 23, may reserve allocations for annotations, 25, for a user, or automated process, 26, who has not yet contributed an annotation, but who has been solicited to create an annotation for the annotated object, 23. There is no bounding on the number of contributing users who may be solicited.

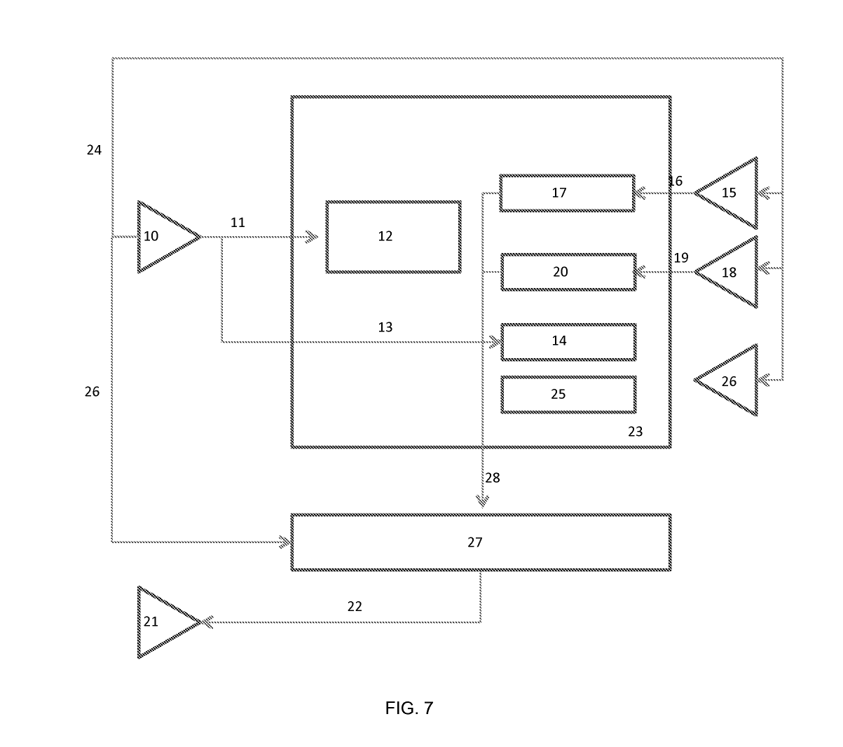

As illustrated in FIG. 7, the collection of annotations, 17, 20, 14, within the annotated object, 23, may be consumed in an order desired by the consumer, 21, or in an order determined by the creator, 10, based on preference expressed by the creator, 10, at the time of creation, 11, or subsequently. It is unique in the art in that the ordering of annotations related to an object can have consumption controlled by the creator of the object. Yet the disclosed invention allows consumers 15, 18, 26, to select an order of consumption, or individual annotations consumption.

While annotations are related to a given source object and are maintained as part of an annotated object, they are searchable and provide indexes for the annotated object, with each annotated object being searchable by a user, or programmatic method, by both metadata contained within each annotation, and content of the annotation itself, whether it be text, digital audio, digital image, or other searchable object type. Such searches may retrieve the annotation alone, or provide index to the annotated object.

Providing further detail, and describing a novel approach to the consumption of annotations within an annotated object, 23, is the mechanism wherein multiple of the annotations may be consumed simultaneously; for example, and not limited to this example, each annotation may contain separate elements of a song contributed by different users over time as separate annotations that are then consumed simultaneously to re-create the multiple elements of the song, which is illustrated in FIG. 7.

In the case of text and other visually oriented annotations, the consumption controlled by the ordering process, 27, previously described, may deliver and display text and other visually oriented annotations in such as a way as to present a “conversation” or “chat” view of the annotations. Meaning that the consuming user, 21, may not see simply a collection of discrete annotations, but rather annotations formatted in such a way as to present a conversation that appears linear in time.

Likewise, the originating user, 10, or an automated process working on the originating user's behalf, may specify any ordering to enforce that a consuming user, 21, may only consume annotations in an order dictated by the originating user. An example of application of this is, but is not limited to, interactive stories or games, where the annotation consumption varies based upon conditions defined by the originating user.

Further, the originating user, 10, or any contributing users, exampled by 15 and 18, may specify access control permissions on any annotation, or the source object in the case of the originating user, to limit the consumption of any of these elements only to users of their choosing. Such access control may include, but is not limited to, consumption, playing or viewing of media, modification of the annotation or source object, deletion of the annotation of the source object, or any other functional mechanism that the implementation of the disclosed invention may provide.

In more detail, the originating user, 10, or any contributing users, exampled by 15 and 18, may specify consumption behavior for an annotation based on environmental factors. Such behavior may include, but is not limited to, the suppression of playback of an annotation, volume control for playback of annotation, automatic muting of playback of annotation, brightness of display, or other factors that may be appropriate for consumption of an annotation. Environmental factors controlling such consumption behavior may include, but is not limited to, the consuming user's geographic location as delivered by location sensing instrumentation in the users computing device, co-location of other users, manual activation of controls by consuming user, or other environmental factors that may be appropriate to control behavior of consumption.

A user, 10, may create an annotated object, 23, and via the mechanism described previously solicit annotations, 24, and have such annotations, 17, 20, and 14, become a part of the annotated object, 23. The creating user, 10, may then specify, 26, a consumption policy, 27, that denotes that multiple of the annotations, 17 and 20, must be consumed simultaneously.

During consumption, the consuming user, 21, initiates the consumption process, 22, and the creating user's consumption policy, 27, forces that some elements, 17 and 20 in the illustrated example, are consumed simultaneously.

The annotated object, 23, may be consumed with the mechanisms implemented to support the disclosed invention, but may also be exported for consumption by more traditionally provided content consumption and media playback mechanisms. The annotated object may be exported for playback as a conventional digital movie file, with each of the audio annotations provided within the audio tracks of that digital movie file, examples include, but are not limited to, AVI files, QuickTime movie files, Flash movie files, and MPEG movie files.

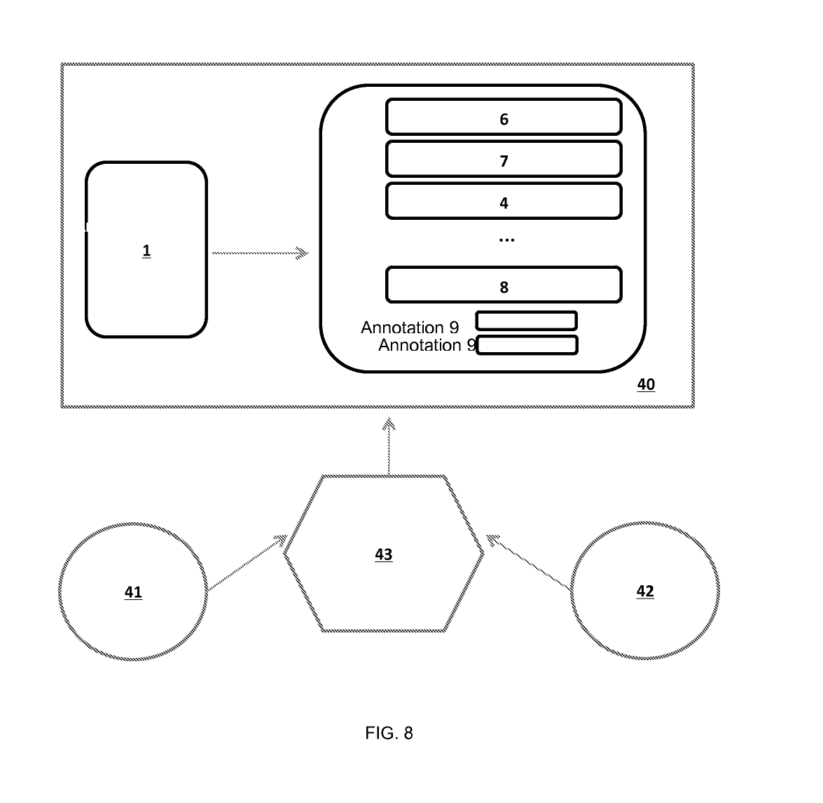

FIG. 8 illustrates an embodiment of the disclosed invention using a global communications networks such as the Internet. FIG. 8 illustrates a user, 41, creating a digital object, 1, and submits it via a computer network, 43, into the relationship stored within a remote relational database system, 40; subsequently, a user, 42, submits an annotation or overlay, 6, via a computer network, 43, resulting in an updated annotated object, 40. It is feature of the disclosed invention that the set of relationships that define an annotated object are distributed and not specifically linked to a specific user.

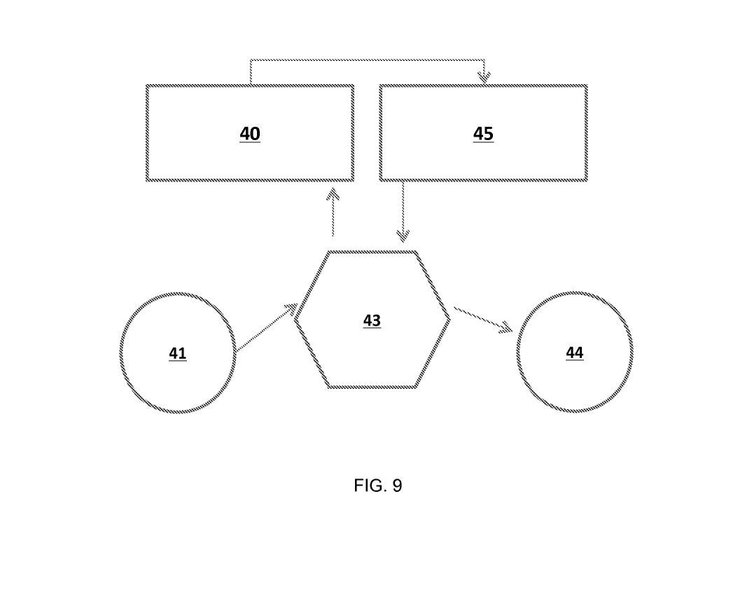

FIG. 9 illustrates another embodiment of the disclosed invention using a global communications networks such as the Internet. FIG. 9 illustrates a user, 41, updating an annotated object, 40, via computer network, 43, where a notification mechanism, 45, is triggered, with subsequent notification delivered to receiving user, 44, via a computer network, 43. The uniqueness of the disclosed invention is not the mechanism of notification, but that a user can generate notifications to external users, or automated processes, to solicit annotations for the annotated object from those same users, or automated processes.

Further, and unique to the disclosed invention, the annotated object may be exported for consumption as a stand-alone object that contains both the source object and all related annotations for the purposes of consumption while not connected to computer networks, or while connection with the relational database system containing the relationships between the source object and annotations is not achievable, or for the purposes of local archiving or providing shared consumption outside the bounds of the disclosed invention.

Further, and unique to the disclosed invention, the annotated object may be exported to the format of the original source object, whether it be a JPEG format digital still image, MP3 format audio file, or other standard format, with each of the contributed annotations provided within the metadata associated with the chosen format. As an example, a source object that is an image may be exported from the annotated object into a JPEG format file, and each of the annotations associated with the object may be embedded into the JPEG format file as extended metadata, with the disclosed invention adding fields to the extended EXIF fields defined by the JPEG format.

Exporting the annotated objects as described limits the ability to create new annotations around the object without re-integrating with the disclosed invention and creating a new annotated object from the exported version. Such re-importation and creation is novel and unique to the disclosed invention.

To summarize, this disclosure describes several embodiments for annotating and sharing a digital object with multiple other digital objects. The first embodiment describes a method for instantiating a digital annotated object that includes providing a central object containing media content created by a creating user, wherein a digital object with related and extensible annotated objects can be formed. This embodiment provides a mechanism for that creating user to set access control parameters to limit actors who may provide annotation in the form of related media objects. Further, this embodiment provides a number of related media objects that refer to the original object that serve to annotate that object with additional content. In addition, this embodiment provides a means for allowing additional related media objects to be created by actors other than the creator of the original digital object. Additionally, this embodiment provides a means for digitally representing the relationships between the various media objects that serve as both central object to be annotated and objects that serve as the annotation.

The next embodiment describes a method of providing annotations that reflect an actor's intended emotional response, wherein a digital object with related and extensible annotated objects specific to the actors intended emotional state or response is reflected. This embodiment creates a central digital object that is enabled for annotation. This embodiment then provides a mechanism for providing related media object that reflects opinion or emotion with audio or visual media corresponding to that emotion.

The next embodiment describes a method of instantiating a digital annotated object that is derived from an existing digital annotated object, wherein a digital object with related and extensible annotated objects is created that contains extensible annotated objects as its own annotation. This embodiment creates a digital annotated object as step (a). Next, this embodiment provides in step (b) a mechanism for importing an additional digital annotated object that itself is to provide annotation to the object described in step (a). Then, this embodiment provides in step (c) a mechanism to allow further annotation both on the original digital object in step (a) and the digital annotated object that is itself an annotation in step (b).

The next embodiment describes a method of providing and soliciting annotations for a digital annotated object, wherein a digital object with related and extensible annotated objects is created that contains placeholder annotations reserved for certain actors, with a notification mechanism for those actors to be notified that the placeholders exist. This embodiment provides a central object containing media content. Next, this embodiment provides a mechanism for allowing related media objects that serve as annotation to the original digital object. Further, this embodiment provides a means for reserving the use of some number of annotations to the original object to be annotated for population by certain actors. And then, this embodiment provides a providing a mechanism for notifying certain actors that an annotation is reserved for that actors use.

The next embodiment describes a method of consuming annotations on a digital annotated object, wherein a means and mechanism for consuming media annotations related to a digital annotated object can be achieved in a controlled and unique fashion. This embodiment provides a central object containing media content and related media based annotations. Next, this embodiment provides a means of replaying the media based annotations in an order proscribed by the creator of the central object. Further, this embodiment provides a means of replaying the media based annotations in an order proscribed by the creator of the annotation. Additionally, this embodiment provides a means of replaying multiple annotations simultaneously to provide various effects on the consumer. And then, this embodiment provides a mechanism to provide the conversion of the digital annotations into a format and object that can be consumed outside of the constraints of the system which embodies the disclosed invention.

Other embodiments of the present invention will be apparent to those skilled in the art after considering this disclosure or practicing the disclosed invention. The specification and examples above are exemplary only, with the true scope of the present invention being determined by the following claims.

We claim the following invention:

1. A method for instantiating a digital annotated object, comprising:
(a) providing a central object containing media content created by a creating user;
(b) providing a mechanism for that creating user to set access control parameters to limit actors who may provide annotation in the form of related media objects;
(c) providing a number of related media objects that refer to the original object that serve to annotate that object with additional content;
(d) providing means for allowing additional related media objects to be created by actors other than the creator of the original digital object; and
(e) providing means for digitally representing the relationships between the various media objects that serve as both central object to be annotated and objects that serve as the annotation; and
wherein a digital object with related and extensible annotated objects can be formed.

2. The system made by the method of claim 1.

3. The method of using the method of claim 1.

4. The non-transitory program storage device readable by a computing device that tangibly embodies a program of instructions executable by the computing device to perform the method of claim 1.

5. A method of providing annotations that reflect an actor's intended emotional response, comprising:
(a) creating a central digital object that is enabled for annotation; and
(b) providing a mechanism for providing related media object that reflects opinion or emotion with audio or visual media corresponding to that emotion; and
wherein a digital object with related and extensible annotated objects specific to the actors intended emotional state or response is reflected.

6. The system made by the method of claim 5.

7. The method of using the method of claim 5.

8. The non-transitory program storage device readable by a computing device that tangibly embodies a program of instructions executable by the computing device to perform the method of claim 5.

9. A method of instantiating a digital annotated object that is derived from an existing digital annotated object, comprising:
(a) creating a digital annotated object;
(b) providing a mechanism for importing an additional digital annotated object that itself is to provide annotation to the object described in step (a);
(c) providing a mechanism to allow further annotation both on the original digital object in step (a) and the digital annotated object that is itself an annotation in step (b); and
wherein a digital object with related and extensible annotated objects is created that contains extensible annotated objects as its own annotation.

10. The system made by the method of claim 9.

11. The method of using the method of claim 9.

12. The non-transitory program storage device readable by a computing device that tangibly embodies a program of instructions executable by the computing device to perform the method of claim 9.

13. A method of providing and soliciting annotations for a digital annotated object, comprising:
(a) providing a central object containing media content;
(b) providing a mechanism for allowing related media objects that serve as annotation to the original digital object;
(c) providing a means for reserving the use of some number of annotations to the original object to be annotated for population by certain actors;
(d) providing a mechanism for notifying certain actors that an annotation is reserved for that actors use; and
wherein a digital object with related and extensible annotated objects is created that contains placeholder annotations reserved for certain actors, with a notification mechanism for those actors to be notified that the placeholders exist.

14. The system made by the method of claim 13.

15. The method of using the method of claim 13.

16. The non-transitory program storage device readable by a computing device that tangibly embodies a program of instructions executable by the computing device to perform the method of claim 13.

17. A method of consuming annotations on a digital annotated object, comprising:
(a) providing a central object containing media content and related media based annotations, and
(b) providing a means of replaying the media based annotations in an order proscribed by the creator of the central object, and
(c) providing a means of replaying the media based annotations in an order proscribed by the creator of the annotation, and
(d) providing a means of replaying multiple annotations simultaneously to provide various effects on the consumer, and
(e) providing a mechanism to provide the conversion of the digital annotations into a format and object that can be consumed outside of the constraints of the system which embodies this invention; and
wherein a means and mechanism for consuming media annotations related to a digital annotated object can be achieved in a controlled and unique fashion.

18. The system made by the method of claim 17.

19. The method of using the method of claim 17.

20. The non-transitory program storage device readable by a computing device that tangibly embodies a program of instructions executable by the computing device to perform the method of claim 17.
